(19) United States
(12) Patent Application Publication
(10) Pub. No.: US 2009/0079198 A1
(43) Pub. Date: Mar. 26, 2009

(54) PROTECTIVE COVER FOR AN ELECTRIC GENERATING DEVICE USING WIND ENERGY

(76) Inventor: Hao-Wei Poo, Taipei City (TW)

Correspondence Address: LADAS & PARRY LLP, 224 SOUTH MICHIGAN AVENUE, SUITE 1600, CHICAGO, IL, 60604, US

(21) Appl. No.: 11/861,429

(22) Filed: Sep. 26, 2007

(51) Int. Cl. F03D 9/00

(52) U.S. Cl. 290/55

(57) ABSTRACT

A protective cover includes a looped surrounding wall disposed on a base of an electric generating device and around an upright blade unit of the electric generating device, and a top wall having a periphery connected to a top end of the surrounding wall and cooperating with the surrounding wall so as to define an accommodating space for receiving the blade unit therein. The surrounding wall is formed with a plurality of vertical rows of rectangular vent holes therethrough, and has an outer surrounding surface formed with a plurality of flaps each extending outwardly and downwardly from a corresponding part of the surrounding wall defining an upper end of a respective vent hole.

### BACKGROUND OF THE INVENTION

1. Field of the Invention

The invention relates to a protective cover, more particularly to a protective cover for an electric generating device using wind energy.

2. Description of the Related Art

Referring to FIG. 1, a conventional electric generating device 1 using wind energy is shown to include a base 11, and an upright blade unit 12 mounted on and rotatable relative to the base 11 so as to convert wind energy into a mechanical rotary power output. The blade unit 12 is coupled to a generator (not shown) such that the generator converts the mechanical rotary power output into electric power.

However, since the conventional electric generating device 1 lacks a protective cover for the blade unit 12, impact of birds or the like against the blade unit 12 cannot be avoided during operation.

### SUMMARY OF THE INVENTION

Therefore, the object of the present invention is to provide a protective cover for an electric generating device using wind energy that can overcome the aforesaid drawback of the prior art.

According to one aspect of the present invention, there is provided a protective cover for an electric generating device. The electric generating device includes a base, and an upright blade unit mounted rotatably on the base. The protective cover comprises:

a looped surrounding wall adapted to be disposed on the base and around the upright blade unit of the electric generating device; and

a top wall having a periphery connected to a top end of the looped surrounding wall and cooperating with the looped surrounding wall so as to define an accommodating space adapted for receiving the blade unit therein.

The looped surrounding wall is formed with a plurality of vertical rows of rectangular vent holes therethrough, and has an outer surrounding surface formed with a plurality of flaps each extending outwardly and downwardly from a corresponding part of the looped surrounding wall defining an upper end of a respective one of the vent holes.

According to another aspect of the present invention, there is provided an electric generating device using wind energy. The electric generating device comprises:

a base;

an upright blade unit mounted rotatably on the base; and

a protective cover disposed on the base for covering the upright blade unit, the protective cover including

a looped surrounding wall mounted on the base and around the upright blade unit, and

a top wall having a periphery connected to a top end of the looped surrounding wall and cooperating with the looped surrounding wall so as to define an accommodating space for receiving the blade unit therein.

The looped surrounding wall is formed with a plurality of vertical rows of rectangular vent holes therethrough, and has an outer surrounding surface formed with a plurality of flaps each extending outwardly and downwardly from a corresponding part of the looped surrounding wall defining an upper end of a respective one of the vent holes.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional electric generating device using wind energy;

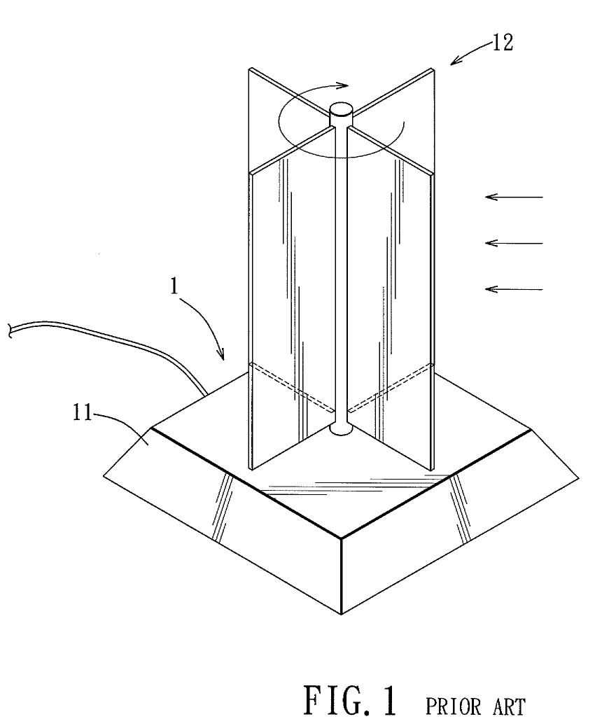

FIG. 2 is a partly exploded perspective showing the first preferred embodiment of an electric generating device using wind energy according to the present invention;

FIG. 3 is a partly sectional schematic side view showing the first preferred embodiment;

FIG. 4 is a perspective view showing the second preferred embodiment of an electric generating device using wind energy according to the present invention; and

FIG. 5 is a schematic top view showing the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

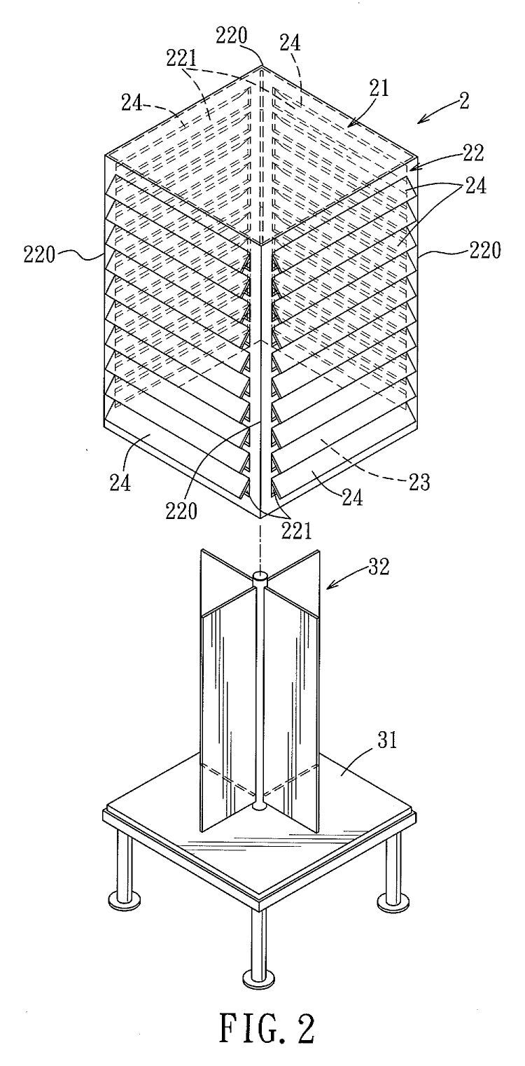

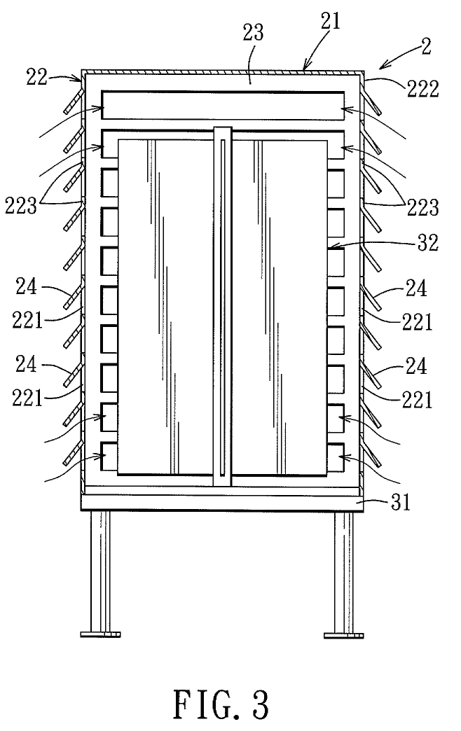

Referring to FIGS. 2 and 3, the first preferred embodiment of an electric generating device using wind energy according to the present invention is shown to include a base 31, an upright blade unit 32, and a protective cover 2.

The blade unit 32 is mounted on the base 31, and is rotatable relative to the base 31 for converting wind energy into a mechanical rotary power output that is in turn converted into electric power by a generator (not shown) coupled to the blade unit 32.

The protective cover 2 is disposed on the base 31 for covering the blade unit 32. The protective cover 2 includes a looped surrounding wall 22 and a top wall 21. The looped surrounding wall 22 is mounted on the base 31 and around the upright blade unit 32. The top wall 21 has a periphery connected to a top end of the looped surrounding wall 21 and cooperating with the looped surrounding wall 21 so as to define an accommodating space 23 for receiving the blade unit 32 therein. In this embodiment, the looped surrounding wall 22 has four wall portions arranged so that the looped surrounding wall 22 is square in cross section, and has four corner portions 220.

The looped surrounding wall 22 is formed with four vertical rows of rectangular vent holes 221 therethrough, and has an outer surrounding surface 222 formed with a plurality of flaps 24 each extending outwardly and downwardly from a corresponding part 223 of the looped surrounding wall 22 defining an upper end of a respective one of the vent holes 221, as shown in FIG. 3.

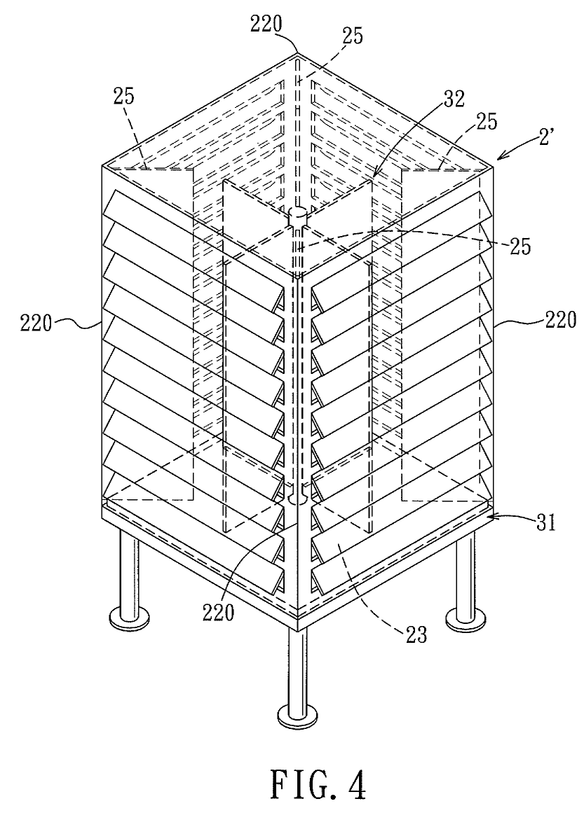

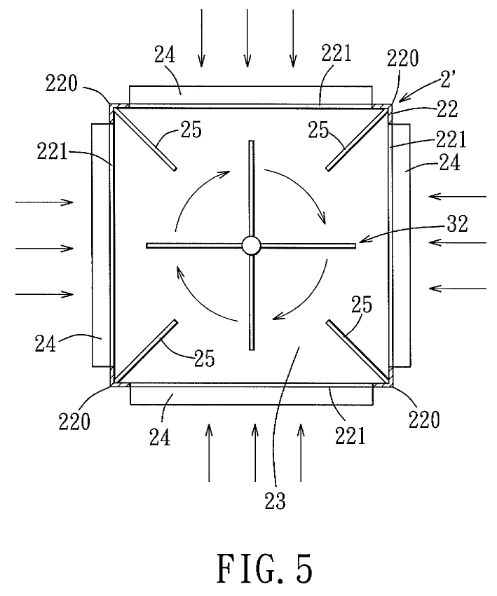

FIGS. 4 and 5 illustrate the second preferred embodiment of an electric generating device using wind energy according to this invention, which is a modification of the first preferred embodiment. In this embodiment, the protective cover 2′ further includes four wind guiding plates 25 disposed in the accommodating space 23 and extending from a respective one of the four corner portions 220 of the looped surrounding wall 22 in a corresponding one of two diagonal directions crossing each other.

In such a configuration, with the protective cover 2, 2′, air flows into the accommodating space 23 through the vent holes 221 in the looped surrounding wall 22, and due to the presence of the flaps 24, birds cannot fly into the accommodating space 23, thereby avoiding impact of birds against the blade unit 32 as encountered in the prior art.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A protective cover for an electric generating device using wind energy, the electric generating device including a base, and an upright blade unit mounted rotatably on the base, said protective cover comprising:
a looped surrounding wall adapted to be disposed on the base and around the upright blade unit of the electric generating device; and
a top wall having a periphery connected to a top end of said looped surrounding wall and cooperating with said looped surrounding wall so as to define an accommodating space adapted for receiving the blade unit therein;
wherein said looped surrounding wall is formed with a plurality of vertical rows of rectangular vent holes therethrough, and has an outer surrounding surface formed with a plurality of flaps each extending outwardly and downwardly from a corresponding part of said looped surrounding wall defining an upper end of a respective one of said vent holes.

2. The protective cover as claimed in claim 1, wherein said looped surrounding wall is square in cross section, and has four corner portions, and said protective cover further comprises four wind guiding plates each disposed in said accommodating space and extending from a respective one of said four corner portions of said looped surrounding wall in a corresponding one of two diagonal directions crossing each other.

3. An electric generating device using wind energy, comprising:
a base;
an upright blade unit mounted rotatably on said base; and
a protective cover disposed on said base for covering said upright blade unit, said protective cover including
a looped surrounding wall mounted on said base and around said upright blade unit, and
a top wall having a periphery connected to a top end of said looped surrounding wall and cooperating with said looped surrounding wall so as to define an accommodating space for receiving said blade unit therein;
wherein said looped surrounding wall is formed with a plurality of vertical rows of rectangular vent holes therethrough, and has an outer surrounding surface formed with a plurality of flaps each extending outwardly and downwardly from a corresponding part of said looped surrounding wall defining an upper end of a respective one of said vent holes.

4. The electric generating device as claimed in claim 3, wherein:
said looped surrounding wall is square in cross section, and has four corner portions; and
said protective cover further includes four wind guiding plates each disposed in said accommodating space and extending from a respective one of said four corner portions of said looped surrounding wall in a corresponding one of two diagonal directions crossing each other.
